(19) United States
(12) Patent Application Publication
(10) Pub. No.: US 2012/0089634 A1
(43) Pub. Date: Apr. 12, 2012

(54) SYSTEM AND METHOD FOR PROVIDING MULTIMEDIA SERVICE IN A COMMUNICATION SYSTEM

(75) Inventors: Mi-Ran CHOI, Daejeon (KR); Myung-Gil Jang, Daejeon (KR); Hyo-Jung Oh, Daejeon (KR); Jeong Heo, Daejeon (KR); Pum-Mo Ryu, Daejeon (KR); Yoon-Jae Choi, Gangwon-do (KR); Chang-Ki Lee, Daejeon (KR); Ji-Ae Shin, Daejeon (KR); Hyun-Ki Kim, Daejeon (KR); Soo-Jong Lim, Daejeon (KR); Yeo-Chan Yoon, Seoul (KR); Chung-Hee Lee, Daejeon (KR); Sang-Kyu Park, Daejeon (KR)

(73) Assignee: Electronics and Telecommunications Research Institute, Daejeon (KR)

(21) Appl. No.: 13/269,521

(22) Filed: Oct. 7, 2011

(30) Foreign Application Priority Data
Oct. 8, 2010 (KR) 10-2010-0098473
Oct. 6, 2011 (KR) 10-2011-0101937

(51) Int. Cl. G06F 17/30; G06F 15/16

(52) U.S. Cl. 707/769; 707/E17.014

(57) ABSTRACT

In a method for providing multimedia services in a communication system, a request message for requesting contract information on users' multimedia services are received from a terminal according to service requests of the multimedia services to be received by the users. A query message for searching for the contract information in a database is generated corresponding to the request message, and the query message is transmitted to the database. The contract information is searched in the database through a Moving Picture Experts Group (MPEG) query format protocol based on the query message, and a query result message containing the contract information is received from the database in response to the query message. The contract information is acknowledged in the query result message, and a response message containing the contract information is generated. Then, the response message is transmitted to the terminal.

### CROSS-REFERENCES TO RELATED APPLICATIONS

The present application claims priority of Korean Patent Application Nos. 10-2010-0098473 and 10-2011-0101937, filed on Oct. 8, 2010, and Oct. 6, 2011, respectively, which are incorporated herein by reference in their entirety.

### BACKGROUND OF THE INVENTION

1. Field of the Invention

Exemplary embodiments of the present invention relate to a communication system; and, more particularly, to a system and method for quickly and stably providing users with various types of multimedia services by rapidly and exactly searching for contract information on users' multimedia services so as to provide the users with the multimedia services in a communication system.

2. Description of Related Art

In communication systems, studies have been actively conducted to provide users with services which have various qualities of service (hereinafter referred to as ‘QoS’) at a high transmission speed. In the communication systems, there are proposed plans for quickly and stably transmitting various types of service data to users through limited resources according to users' service requests to receive various types of services and providing the services requested by the respective users.

Meanwhile, in a current communication system, there are proposed plans for providing large-capacity service data at a high speed according to users' various service requests. Particularly, studies have actively conducted to develop a plan for transmitting large-capacity multimedia data at a high speed according to users' service requests to receive various multimedia services. In other words, users desire to receive various multimedia services of higher quality through the communication system. Particularly, the users receive their desired multimedia services according to contract information on their multimedia services. Therefore, users' contract information on their various multimedia services should be precisely acknowledged so as to provide the various multimedia services to the users.

However, a specific plan for precisely acknowledging users' contract information on their various multimedia services so as to provide the users with the various multimedia services is not proposed in the current communication system. That is, a plan for rapidly and exactly searching for contract information on various multimedia services to be provided to users in a database of a service provider, in which users contract information on users' multimedia services are stored, has not yet proposed in the current communication system. Accordingly, since contract information on multimedia services to be provided to users is not precisely acknowledged, there is a limitation in stably providing the multimedia services to the users. Particularly, a specific plan for rapidly and exactly searching for contract information on multimedia services requested by users according to users' multimedia service requests is not proposed in the communication system.

Therefore, it is required to develop a plan for quickly and stably providing various multimedia services to users by rapidly and rapidly and exactly searching for contract information users' various multimedia services according to users' various multimedia service requests and precisely acknowledging the contract information in a communication system.

### SUMMARY OF THE INVENTION

An embodiment of the present invention is directed to a system and method for providing multimedia services in a communication system.

Another embodiment of the present invention is directed to a system and method for quickly and stably providing users with various types of multimedia services by rapidly and exactly searching for contract information on users' multimedia services according to users various multimedia service requests in a communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a system for providing multimedia services in a communication system includes a reception unit configured to receive, from a terminal, a request message for requesting contract information on users' multimedia services according to service requests of the multimedia services to be received by the users; a generation unit configured to generate a query message for searching for the contract information in a database, corresponding to the request message, acknowledge the contract information in a query result message received in response to the query message and then generate a response message containing the contract information; and a transmission unit configured to transmit the query message to the database and transmit, to the terminal, the response message containing the contract information in response to the request message. In the system, the reception unit receives, from the database, the query result message containing the contract information in response to the query message.

In accordance with another embodiment of the present invention, a system for providing multimedia services in a communication system includes a generation unit configured to generate a request message for requesting contract information on users' multimedia services according to service requests of the multimedia services to be received by the users; a transmission/reception unit configured to transmit the request message to a service provider (SP) and receive, from the SP, a response message containing the contract information in response to the request message; and an acknowledgement unit configured to acknowledge the contract information contained in the response message. In the system, the contract information is searched in a database receiving a query message corresponding to the request message.

In accordance with another embodiment of the present invention, a method for providing multimedia services in a communication system includes receiving, from a terminal, a request message for requesting contract information on users' multimedia services according to service requests of the multimedia services to be received by the users; generating a query message for searching for the contract information in a database, corresponding to the request message, and transmitting the query message to the database; searching for the contract information in the database through a Moving Picture Experts Group (MPEG) query format protocol based on the query message, and receiving, from the database, a query result message containing the contract information in response to the query message; and acknowledging the contract information in the query result message, generating a response message containing the contract information and then transmitting the response message to the terminal.

In accordance with another embodiment of the present invention, a method for providing multimedia services in a communication system includes generating a request message for requesting contract information on users' multimedia services according to service requests of the multimedia services to be received by the users; transmitting the request message to an SP; searching for the contract information in the database based on a query message corresponding to the request message, and receiving, from the SP, a response message containing the contract information in response to the request message; and acknowledging the contract information contained in the response message. In the method, the request message, the response message and the query message are transmitted/received through a search protocol.

### BRIEF DESCRIPTION OF THE DRAWINGS

FIG. 1 schematically illustrates the structure of a terminal of a system for providing multimedia services in a communication system in accordance with an embodiment of the present invention.

FIG. 2 schematically illustrates the structure of a service provider (SP) of the system for providing multimedia services in the communication system in accordance with the embodiment of the present invention.

FIG. 3 schematically illustrates a message transmitting/receiving process of the system for providing multimedia services in the communication system in accordance with the embodiment of the present invention.

FIGS. 4 to 8 schematically illustrate search protocol and message types of the system for providing multimedia services in the communication system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a system and method for quickly and stably providing users with various multimedia services in a communication system. In embodiments of the present invention, various multimedia services are quickly and stably provided to users by rapidly and exactly searching for contract information on users' various multimedia services according to users' service requests to receive the various multimedia services.

In the embodiments of the present invention, when a terminal for providing users with various multimedia services in a communication system requests contract information on users' various multimedia services, the contract information is rapidly and exactly searched, and the searched contract information is provided to the terminal. Accordingly, the various multimedia services are quickly and stably provided to the users through the terminal. In the embodiments of the present invention, according to a request of contract information on various multimedia services in a terminal for providing users with the various multimedia services, e.g., a terminal of a Moving Picture Experts Group (MPEG) Advanced Internet Protocol Television (IPTV) system, the contract information stored in a database (hereinafter, referred to as a ‘DB’) of a service provider (hereinafter, referred to as an ‘SP’) for providing the various multimedia services is rapidly and exactly searched, and the searched contract information is provided to the terminal. Although a case where a terminal requests contract information on users' various multimedia services in the MPEG Advanced IPTV system is mainly described in the embodiments of the present invention, it may be applied not only to the MPEG Advanced IPTV system proposed in the present invention but also to other communication systems.

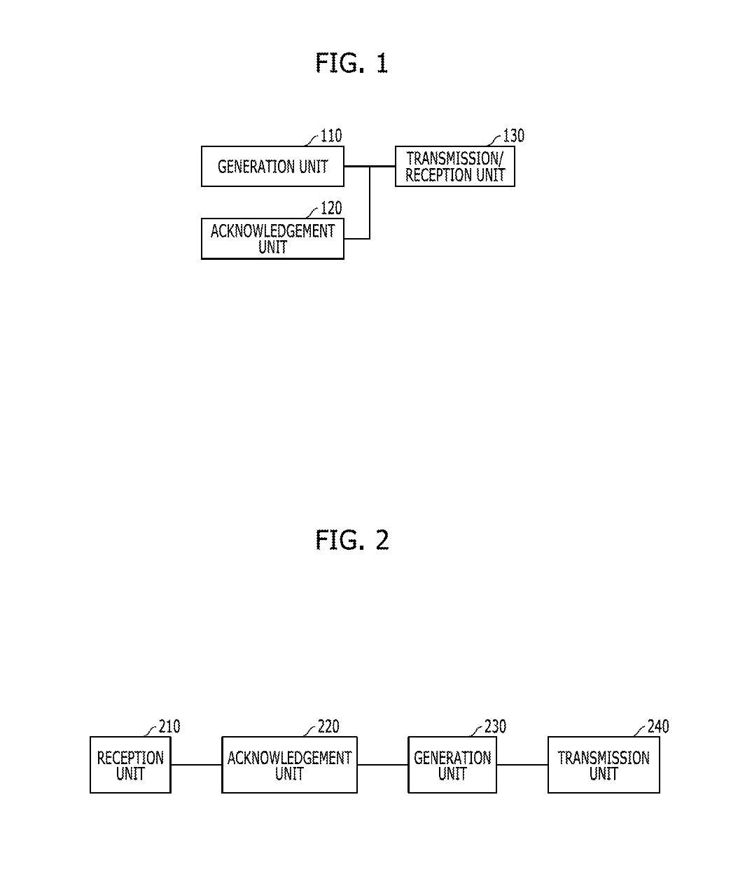

In the embodiments of the present invention, according to a request of contract information on various multimedia services of a terminal in a communication system, search protocols and messages for rapidly and exactly searching for the contract information in a DB are defined, and the messages are transmitted/received through the defined search protocols, so that the various multimedia services are provided to users by rapidly and exactly searching for the contract information in the DB. The contract information on the various multimedia services contains copyright information, users' service subscription information, user information, content information, implement information, group information and license information on the various multimedia services. The contract information is expressed by a predetermined language. Hereinafter, a terminal of a system for providing a multimedia service in a communication system in accordance with an embodiment of the present invention will be described in detail with reference to FIG. 1.

FIG. 1 schematically illustrates the structure of a terminal of a system for providing multimedia services in a communication system in accordance with an embodiment of the present invention.

Referring to FIG. 1, the terminal includes a generation unit 110, a transmission/reception unit 130 and an acknowledgement unit 120 so as to provide users with various multimedia services. The generation unit 110 generates a request message for requesting contract information on the users' various multimedia services. The transmission/reception unit 130 transmits the request message to an SP and receives a response message corresponding to the request message from the SP. The acknowledgement unit 120 acknowledges contract information on the users' various multimedia services, contained in the response message. Here, the terminal provides users with various multimedia services by acknowledging contract information on the users' various multimedia services and then processing and expressing contents of the various multimedia services so as to provide the users with the various multimedia services in an MPEG Advanced IPTV system.

The generation unit 110 generates a request message, e.g., Search Contract Request, for requesting the SP to search for the contract information on the users' various multimedia services in a DB of the SP.

The transmission/reception unit 130 transmits the Search Contract Request to the SP, and receives, from the SP, a response message, e.g., a search contract response, in which the contract information on the users' various multimedia services is contained, corresponding to the Search Contract Request transmitted to the SP. Here, the transmission/reception unit 130 receives a reception acknowledgement message (acknowledgement (Ack)) of the Search Contract Request from the SP receiving the Search Contract Request, and transmits an Ack of the search contract response to the SP.

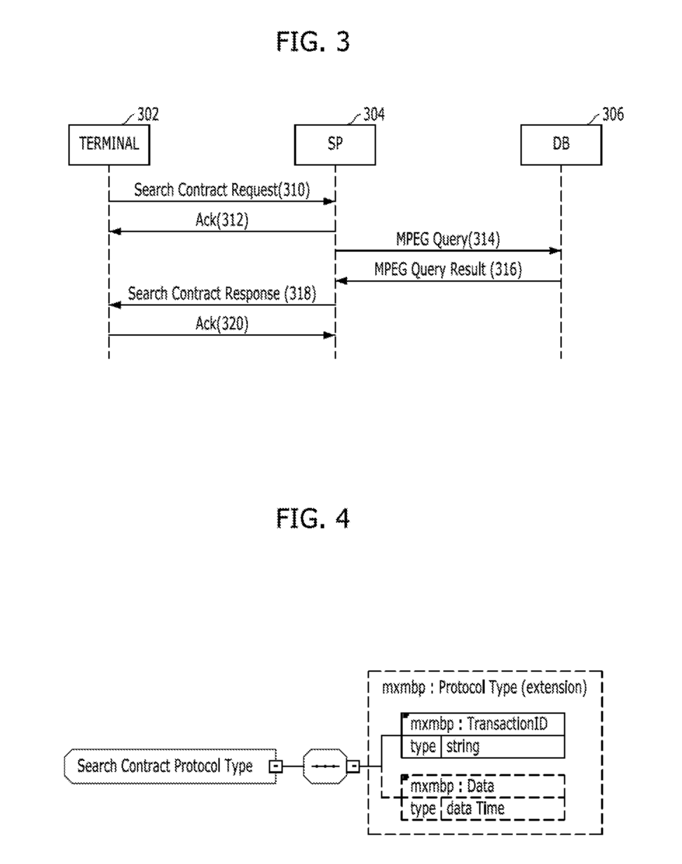

The acknowledgement unit 120 acknowledges the contract information on the users' various multimedia services, contained in the search contract response received from the SP, and the terminal stably provides the users with the various multimedia services according to the contract information on the users' various multimedia services. Hereinafter, an SP of the system for providing multimedia services in the communication system in accordance with the embodiment of the present invention will be described with reference to FIG. 2.

FIG. 2 schematically illustrates the structure of an SP of the system for providing multimedia services in the communication system in accordance with the embodiment of the present invention.

Referring to FIG. 2, the SP includes a reception unit 210, an acknowledgement unit 220, a generation unit 230 and a transmission unit 240 so as to provide users with various multimedia services. The reception unit 210 receives, from the terminal, a request message for requesting contract information on the users' various multimedia services. The acknowledgement unit 220 searches for the contract information on the users' various multimedia services, stored in a DB, corresponding to the request message received from the terminal, and acknowledges the searched contract information. The generation unit 230 generates a response message containing the contract information on the users' various multimedia services, corresponding to the request message. The transmission unit 240 transmits the response message to the terminal. Here, the DB for storing the contract information on the users' various multimedia services may be included in the inside of the SP or may separately exist outside the SP. Hereinafter, for convenience of illustration, a case where the DB as an independent object exists separately from the SP will be described.

The reception unit 210 receives, from the terminal, a request message, e.g., Search Contract Request, for requesting the SP to search for the contract information on the users' various multimedia services in the DB of the SP.

The acknowledgement unit 220 acknowledges the contract information on the users' various multimedia services, to be searched in the DB, from the Search Contract Request received from the reception unit 210 so as to provide the users with the various multimedia services.

The generation unit 230 generates a query message, e.g., MPEG Query so as to search for the contract information in the DB using a search protocol, e.g., MPEG Query Format Protocol, corresponding to the contract information on the users' various multimedia services, acknowledged by the acknowledgement unit 220, i.e., corresponding to the Search Contract Request. The transmission unit 240 transmits the MPEG Query to the DB so that the contract information is searched in the DB.

Here, the contract information on the users' various multimedia services is rapidly and exactly searched in the DB through the MPEG Query Format Protocol. The reception unit 210 receives a query result message, e.g., MPEG Query Result containing the contract information on the users' various multimedia services, searched as described above.

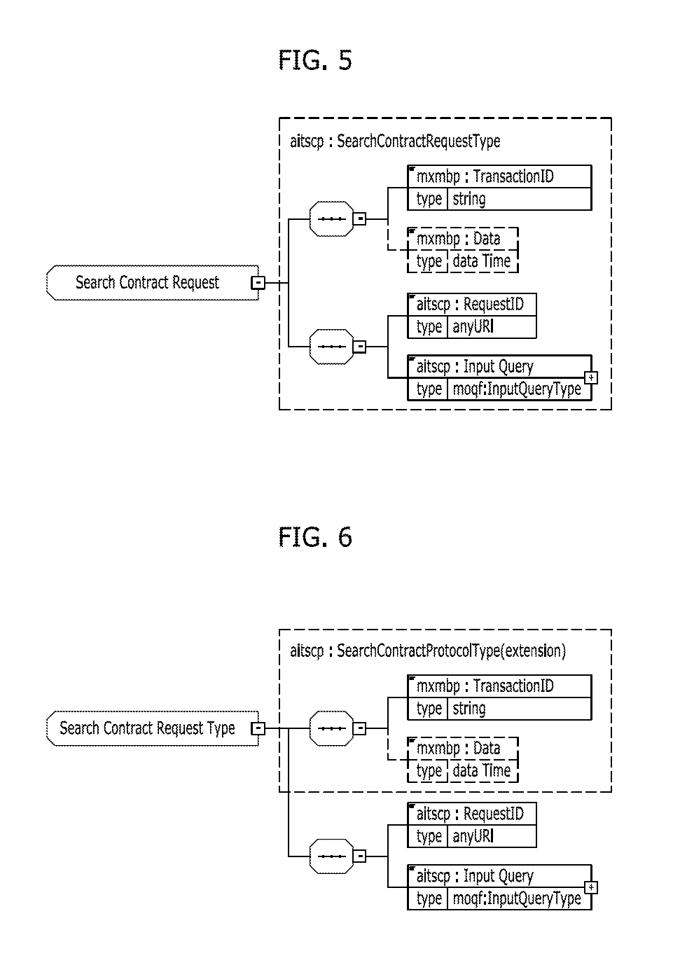

The acknowledgement unit 220 acknowledges the contract information on the users' various multimedia services, contained in the MPEG Query Result. The generation unit 230 generates a response message, e.g., Search Contract Response, containing the acknowledged contract information, in response to the Search Contract Request. The transmission unit 240 transmits, to the terminal, the Search Contract Result containing the contract information on the users' various multimedia services. Here, the transmission unit 240 transmits, to the terminal, a reception acknowledgement message (Ack) of the Search Contract Request, and the reception unit 210 receives the Ack of the Search Contract Response from the terminal. Hereinafter, an operation of searching contract information on various multimedia services and providing the searched contract information on the various multimedia services of the system for providing multimedia services in the communication system in accordance with the embodiment of the present invention will be described in detail with reference to FIG. 3.

FIG. 3 schematically illustrates a message transmitting/receiving process of the system for providing multimedia services in the communication system in accordance with the embodiment of the present invention.

Referring to FIG. 3, in order to provide users with various multimedia services, a terminal 302 transmits, to an SP 304, a search contract information request message (Search Contract Request) for requesting a contract information request so as to request contract information on the users' various multimedia services (step 310).

The SP 304 receiving the Search Contract Request from the terminal 302 transmits a reception acknowledgement message (Ack) of the Search Contract Request to the terminal 302 (step 312). The SP 304 transmits an MPEG query message (MPEG Query) to a DB 306 so as to search for the contract information on the users' various multimedia services in the DB 306 through a search protocol, e.g., MPEG Query Format Protocol, corresponding to the Search Contract Request (step 314).

The DB 306 receiving the MPEG Query from the SP 304 searches for the contract information on the users' various multimedia services, stored through the MPEG Query Format Protocol, and transmits, to the SP 304, an MPEG query result message (MPEG Query Result) containing the contract information on the users' various multimedia services, searched as described above (step 316).

Then, the SP 304 receives, from the DB 306, the MPEG Query Result containing the contract information on the users' various multimedia services in response to the MPEG Query, and acknowledges the contract information on the users' various multimedia services, contained in the MPEG Query Result. The SP 304 transmits, to the terminal 302, a search contract information response message (Search Contract Response) containing the contract information on the users' various multimedia services in response to the Search Contract Request (step 318).

Next, the terminal 302 acknowledges the contract information on the users' various multimedia services by receiving the Search Contract Response containing the contract information on the users' various multimedia services, and transmits a reception acknowledgement message (Ack) of the Search Contract Response to the SP 304 (step 320).

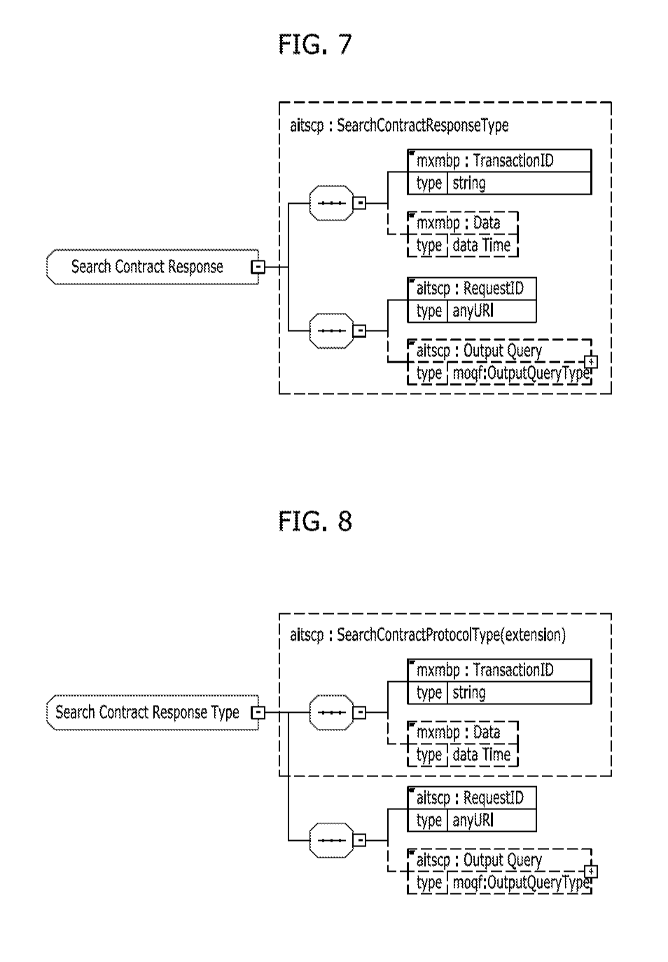

In the system for providing multimedia services in accordance with the embodiment of the present invention, each search protocol and message for rapidly and exactly searching for the contract information on the users' various multimedia services, stored in the DB 306, are defined so as to provide the users with the various multimedia services according to users' various multimedia service requests. The message defined as described above are transmitted/received among the terminal 302, the SP 304 and DB 306 through the search protocol. In addition, the message is transmitted/received through the search protocol, e.g., the MPEG Query Format Protocol, thereby rapidly and exactly searching for the contract information on the users' various multimedia services. Hereinafter, search protocol and message types of the system for providing multimedia services in the communication system in accordance with the embodiment of the present invention will be described in detail with reference to FIGS. 4 to 8.

FIGS. 4 to 8 schematically illustrate search protocol and message types of the system for providing multimedia services in the communication system in accordance with the embodiment of the present invention.

Referring to FIGS. 4 to 8, in a case where the MPEG Query Format Protocol is used as a search protocol so as to rapidly and exactly search for the contract information on the users' various multimedia services, stored in the DB in the system for providing the multimedia services, the protocol type of the MPEG Query Format Protocol is illustrated in FIG. 4. That is, the MPEG Query Format Protocol is of a search contract information protocol type (Search Contract Protocol Type), and is defined as an extended protocol type.

In the system for providing multimedia services, the request message, i.e., Search Contract Request, in which the terminal requests the contract information on the users' various multimedia services, is defined as a search contract information request type (Search Contract Request Type) as illustrated in FIG. 5. The Search Contract Request Type is defined as an extended search contract information protocol type (Search Contract Protocol Type) as illustrated in FIG. 6.

In the system for providing multimedia services, the response message, i.e., Search Contract Response containing the contract information on the users' various multimedia services, which the terminal receives as a response for the Search Contract Request from the SP, is defined as a search contract information response type (Search Contract Response Type) as illustrated in FIG. 7. The Search Contract Response Type is defined as an extended search contract information protocol type (Search Contract Protocol Type) as illustrated in FIG. 8.

The message transmitted/received so as to search for the contract information on the users' various multimedia services through the search protocol in the system for providing the multimedia services is described as an eXtensible Markup Language (hereinafter, referred to as ‘XML’) document, and the described XML document is transmitted/received. That is, in the system for providing the multimedia services, the search protocol, the message transmitted/received among the terminal, the SP and the DB, the Search Contract Request, the Search Contract Response, the MPEG Query and the MPEG Query Result are described in an XML schema format.

For example, the search protocol and message for searching for the contract information on the users' various multimedia services are described in the XML schema format as illustrated in Table 1, and Table 1 illustrates a syntax of a protocol data format as a syntax of the search protocol and message. That is, the protocol and message for searching for the contract information on the users' various multimedia services are defined as the syntax of the protocol data format.

```
TABLE 1
  <!-- ################################################ -->
  <!-- Search Contract  -->
  <!-- ################################################ -->
<!-- Definition of SearchContractProtocolType -->
<complexType name=“SearchContractProtocolType” abstract=“true”>
  <complexContent>
    <extension base=“mxmbp:ProtocolType”/>
  </complexContent>
</complexType>
<element name=“Ack” type=“aitscp:AckType”/>
<complexType name=“AckType”>
  <complexContent>
    <extension base=“aitscp:SearchContractProtocolType”>
      <sequence minOccurs=“0”>
        <element ref=“mxmbp:ProtocolResult”/>
      </sequence>
      <attribute name=“Result” type=“boolean”
use=“required”/>
    </extension>
  </complexContent>
</complexType>
<!-- Definition of SearchContractRequest -->
<element name=“SearchContractRequest”
type=“aitscp:SearchContractRequestType”/>
<complexType name=“SearchContractRequestType”>
  <complexContent>
    <extension base=“aitscp:SearchContractProtocolType”>
      <sequence>
        <element name=“RequestID” type= “anyURI”
minOccurs=“1”/>
        <element name=“InputQuery”
type=“mpqf:InputQueryType” minOccurs=“1”/>
      </sequence>
    </extension>
  </complexContent>
</complexType>
<!-- Definition of SearchContractResponse -->
<element name=“SearchContractResponse”
type=“aitscp:SearchContractResponseType”/>
<complexType name=“SearchContractResponseType”>
  <complexContent>
    <extension base=“aitscp:SearchContractProtocolType”>
      <sequence>
        <element name=“RequestID” type=“anyURI”
minOccurs=“1”/>
        <element name=“OutputQuery”
type=“mpqf:OutputQueryType” minOccurs=“0”/>
      </sequence>
    </extension>
  </complexContent>
</complexType>
```

The syntax of the protocol data format, i.e., the protocol data format, illustrated in Table 1, is defined as semantics. That is, the search protocol and message for searching for the contract information on the users' various multimedia services are defined as semantics of the protocol data format as illustrated in Tables 2 to 4. Here, Table 2 illustrates semantics of the Search Contract Protocol Type in the protocol data format of the search protocol and message. Table 3 illustrates semantics of the Search Contract Request Type in the protocol data format of the search protocol and message. Table 4 illustrates semantics of the Search Contract Response Type in the protocol data format of the search protocol and message.

TABLE 2

| Name | Definition |
|---|---|
| SearchContractProtocolType | Top-level type for Search Contract |
| | Protocol messages (abstract). |
| | SearchContractProtocolType extends |
| | mxm:ProtocolType. |

TABLE 3

| Name | Definition |
|---|---|
| SearchContractRequest | Protocol message sent from the User to |
| | the SP to request that certain Contract |
| | is sought under provided terms and |
| | conditions. |
| SearchContractRequestType | Top-level type for SearchContractRequest. |
| | SearchContractRequestType extends |
| | SearchContractProtocolType. |
| RequestID | URI that unambiguously identifies the |
| | request by the User. |
| InputQuery | A set of conditions and/or the |
| | specification of the structure and |
| | content of the output query format and a |
| | declaration part as specified in the MPEG |
| | QF. |

TABLE 4

| Name | Definition |
|---|---|
| SearchContractResponse | Protocol message sent from the SP to the |
| | User with the results of the Search |
| SearchContractResponseType | Top-level type for |
| | SearchContractResponse. |
| | SearchContractResponseType extends |
| | SearchContractProtocolType. |

In the system for providing the multimedia services in accordance with the embodiment of the present invention, each of the search protocols and transmission/reception messages, e.g., request and response messages and query and query result messages, for rapidly and exactly searching for the contract information on the users' various multimedia services, is defined so as to provide the users with the various multimedia services. That is, each of the protocol data formats for the search protocols and messages is defined. Particularly, in the system for providing the multimedia services in accordance with the embodiment of the present invention, the protocol data format for the search protocol and message is defined in the XML schema format. In other words, the syntax and semantics of the protocol data format are defined. After the protocol data format for the search protocol and message is defined, the message is transmitted/received through the search protocol, so that the contract information on the users' various multimedia services is rapidly and exactly searched in the DB. Accordingly, the various multimedia services can be quickly and stably provided to the users by precisely acknowledging the contract information on the users' various multimedia services.

In accordance with the exemplary embodiments of the present invention, contract information on users' various multimedia services is rapidly and exactly searched through search protocols and transmission/reception of messages according to various multimedia service requests to be received by users in a communication system, so that it is possible to precisely acknowledge the contract information on the users' various multimedia services, thereby quickly and stably providing the users with the various multimedia services.

While the present invention has been described with respect to the specific embodiments, it will be apparent to those skilled in the art that various changes and modifications may be made without departing from the spirit and scope of the invention as defined in the following claims.

What is claimed is:

1. A system for providing multimedia services in a communication system, the system comprising:
a reception unit configured to receive, from a terminal, a request message for requesting contract information on users' multimedia services according to service requests of the multimedia services to be received by the users;
a generation unit configured to generate a query message for searching for the contract information in a database, corresponding to the request message, acknowledge the contract information in a query result message received in response to the query message and then generate a response message containing the contract information; and
a transmission unit configured to transmit the query message to the database and transmit, to the terminal, the response message containing the contract information in response to the request message,
wherein the reception unit receives, from the database, the query result message containing the contract information in response to the query message.

2. The system of claim 1, wherein the request message, the response message, the query message and the query result message are transmitted/received through a search protocol.

3. The system of claim 2, wherein the search protocol, the request message, the response message, the query message and the query result message are described in an eXtensible Markup Language (XML) schema format.

4. The system of claim 2, wherein the search protocol, the request message, the response message, the query message and the query result message are defined as a syntax of a protocol data format.

5. The system of claim 2, wherein the search protocol, the request message, the response message, the query message and the query result message are defined as semantics of the protocol data format.

6. The system of claim 2, wherein the contract information is searched in the database through a Moving Picture Experts Group (MPEG) query format protocol.

7. A system for providing multimedia services in a communication system, the system comprising:
a generation unit configured to generate a request message for requesting contract information on users' multimedia services according to service requests of the multimedia services to be received by the users;
a transmission/reception unit configured to transmit the request message to a service provider (SP) and receive, from the SP, a response message containing the contract information in response to the request message; and
an acknowledgement unit configured to acknowledge the contract information contained in the response message,
wherein the contract information is searched in a database receiving a query message corresponding to the request message.

8. The system of claim 7, wherein the request message, the response message and the query message are transmitted/received through a search protocol.

9. The system of claim 8, wherein the search protocol, the request message, the response message and the query message are described in an XML schema format.

10. The system of claim 8, wherein the search protocol, the request message, the response message and the query message are defined as a syntax of a protocol data format.

11. The system of claim 8, wherein the search protocol, the request message, the response message and the query message are defined as semantics of the protocol data format.

12. A method for providing multimedia services in a communication system, the method comprising:
receiving, from a terminal, a request message for requesting contract information on users' multimedia services according to service requests of the multimedia services to be received by the users;
generating a query message for searching for the contract information in a database, corresponding to the request message, and transmitting the query message to the database;
searching for the contract information in the database through an MPEG query format protocol based on the query message, and receiving, from the database, a query result message containing the contract information in response to the query message; and
acknowledging the contract information in the query result message, generating a response message containing the contract information and then transmitting the response message to the terminal.

13. The method of claim 12, wherein the request message, the response message, the query message and the query result message are transmitted/received through a search protocol.

14. The method of claim 13, wherein the search protocol, the request message, the response message, the query message and the query result message are described in an XML schema format.

15. The method of claim 13, wherein the search protocol, the request message, the response message, the query message and the query result message are defined as a syntax of a protocol data format.

16. The method of claim 13, wherein the search protocol, the request message, the response message, the query message and the query result message are defined as semantics of the protocol data format.

17. A method for providing a multimedia system in a communication system, the method comprising:
generating a request message for requesting contract information on users' multimedia services according to service requests of the multimedia services to be received by the users;
transmitting the request message to an SP;
searching for the contract information in the database based on a query message corresponding to the request message, and receiving, from the SP, a response message containing the contract information in response to the request message; and
acknowledging the contract information contained in the response message,
wherein the request message, the response message and the query message are transmitted/received through a search protocol.

18. The method of claim 17, wherein the search protocol, the request message, the response message and the query message are described in an XML schema format.

19. The method of claim 17, wherein the search protocol, the request message, the response message and the query message are defined as a syntax of a protocol data format.

20. The method of claim 17, wherein the search protocol, the request message, the response message and the query message are defined as semantics of the protocol data format.
